(19) United States
(12) Patent Application Publication
(10) Pub. No.: US 2008/0228568 A1
(43) Pub. Date: Sep. 18, 2008

(54) DELIVERY OF COUPONS THROUGH ADVERTISEMENT

(75) Inventors: Charles J. Williams, Redmond, WA (US); Sergey I. Bykov, Redmond, WA (US); Timothy E. Belvin, Woodinville, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/687,240

(22) Filed: Mar. 16, 2007

(51) Int. Cl. G06Q 30/00

(52) U.S. Cl. 705/14

(57) ABSTRACT

Systems and methods that supply associations between advertisements—and—relevance of coupons for customers. Accordingly, the customer is empowered to interact with an advertising system, and the coupons obtained are considered desirable by the customer (e.g., non-spam). The advertisement system includes a presentation component (which presents advertisement to customers); a contextualization component (which analyzes context of purchase related to the advertisement such as location, profile, and basket of the customer), and a dispenser component (which dispenses the coupons based on customer initiation—e.g., pressing a button).

### BACKGROUND

Today, a typical purchase, which involves coupons, would include a customer clipping coupons at home, taking the coupons to the store, and selection of products for check out at a cashier station or point of sale (POS) terminal. Coupons are then redeemed by merchants via settlement thereof through clearing houses and submittal to coupon issuers.

In general, consumers receive coupons through a variety of channels such as: mailings, newspapers, showings on the product itself, or printed at a retail outlet. Moreover, newspapers and leaflets of coupons mailed or delivered to residences of customers still remains the most common channel for delivering coupons to customers. Such printed coupons are presented at the checkout station to obtain a discount on a product. The paper coupons are collected at the POS by the retailer and then sent to a clearinghouse, which in turn separates the coupons and bills respective coupon issuer for reimbursement of the retailer.

Such system has proven itself to cause problems for both customers and retailers. For example, customers have to manually clip desired coupons and sort them by product categories (e.g., detergents, canned foods, cereals, frozen foods, toiletries, and the like) to efficiently find products when shopping at the store. Furthermore, customers have to periodically examine their collection of coupons and discard expired ones. Moreover, retailers also have to expend considerable hours and resources to sort through coupons by manufacturer for redemption, and monitor expired coupons at the checkout station.

Typically, coupons that are collected by a retailer are passed through a clearinghouse for assortment. Such clearinghouse can subsequently pay retailers cash for estimated value of the coupons, wherein a difference between the estimated and actual amount can later be credited or debited. Nevertheless, retailers are still required to monitor for expired coupons and handle coupon collection and submittal to the clearinghouse for payment.

Another problem of such paper coupon system is misredemption. For example, misredemption can occur when a consumer employs a coupon without purchasing an item associated therewith. Likewise, checkout clerks can inappropriately exploit such paper coupon system by interchanging coupons and cash. Misredemption of coupons is estimated to be as high as 20%-30%.

At a high level, conventional advertising techniques typically employ mass media (e.g., television and radio) and heavily traveled areas such as major highways as principal means for reaching large numbers of viewers and listeners with the hope that he or she will see the advertisement (e.g., in the form of billboards or television commercials) and make a purchase. However, such techniques are limited, since the advertisement has to be created to reach a broad spectrum of potential customers.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject innovation supplies associations between advertisements—and—relevance of coupons for customers; via an advertisement system that dispenses coupons upon customer request. The advertisement system includes a presentation component (which presents advertisement to customers); a contextualization component (which analyzes context of purchase related to user activities such as location, profile, and basket of the customer), and a dispenser component (which dispenses coupons, e.g., printing paper coupons or electronic transmittal, based on customer initiation such as pressing a button, for example). Based on contextual information, one or more advertisements can then be selected for display to the customer or group of customers. Moreover, third party advertisers can dynamically update and convey advertisements in real time within traditional retail brick-and-mortar establishments, wherein each ad packet can be customized per potential customer to increase likelihood purchase.

Accordingly, the customer is empowered to interact with the advertising system, and the coupons obtained are considered desirable by the customer (e.g., non-spam). Moreover, since such coupon dispensing is voluntary (e.g., initiated by the customer), data related to “non-usage” of the obtained coupon becomes a valuable marketing criteria.

In a related methodology, contextual relevance of coupons for customers can be increased by tying coupon delivery to advertisement. Initially, an advertisement can be presented to a user. Such presentation can be based on a context analysis for such customer (e.g., presence of a user in predetermined locations, basket, demographics, and the like). Subsequently, the user can be empowered to obtain a coupon related to the displayed advertisement. Upon the user requesting the coupon (e.g., paper, electronic coupon), the system can supply the coupon thereto (e.g., print paper coupon, transmit electronic data to a portable computing unit that is carried by the customer, deposit coupon to customer's coupon wallet/account such as an online account or a customer's account with the merchant).

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of an advertising system in accordance with an aspect of the subject innovation.

FIG. 2 illustrates a contextualization component as part of an advertising system in accordance with an aspect of the subject innovation.

FIG. 3 illustrates a related methodology of delivering a coupon to a customer via an advertising system in accordance with an aspect of the subject innovation.

FIG. 4 illustrates a related methodology of interacting with an advertising system and obtaining a coupon from a displayed advertisement to a user.

FIG. 5 illustrates an advertising system that employs a machine learning and reasoning in accordance with an aspect of the subject innovation.

FIG. 6 illustrates a block diagram of a shopping network system that employs an advertising system with a coupon dispenser, which empowers customers to obtain coupon therefrom.

FIG. 7 illustrates exemplary packet formats for coupon files that customers can obtain from the advertising system of the subject innovation.

FIG. 8 illustrates a further methodology of settling coupons that are obtained via customer initiation, according to a further aspect of the subject innovation.

FIG. 9 illustrates a schematic block diagram of a suitable operating environment for implementing aspects of the subject innovation.

FIG. 10 illustrates a further schematic block diagram of a sample-computing environment for the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

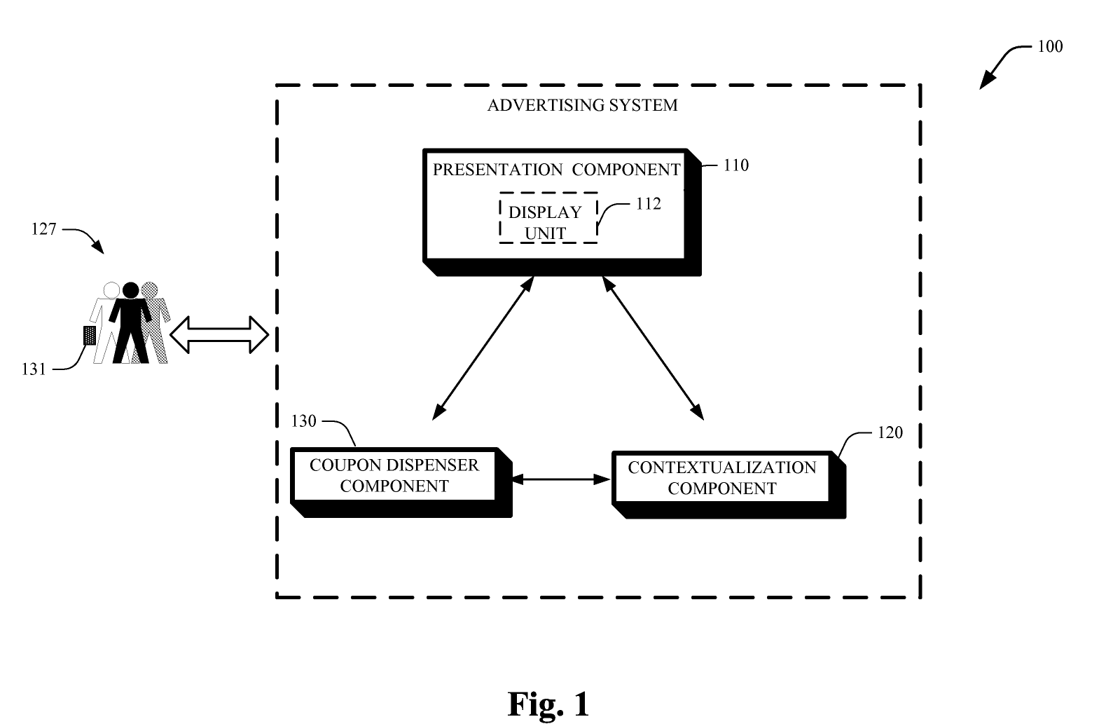

FIG. 1 illustrates a block diagram of an advertising system 100 that enables association between relevance coupons for customers and advertisement in accordance with an aspect of the subject innovation. The advertisement system 100 includes a presentation 110 component that presents advertisement to customers 127. Likewise, a contextualization component 120 can analyze relevance of the advertisement presented to the user in context of users present or past activities—e.g., based on analysis of location, profile, and basket of the customer—as described in detail infra. Moreover, a coupon dispenser component 130 of the advertisement system 100 can dispense coupons based on customer initiation. For example, coupons can be printed by pressing a button, and/or in case of electronic coupons by transmission of an electronic coupon to a smart portable device(s) 131 (e.g., mobile computer, personal digital assistant, cell phone and the like) that can be carried by the customer, for example. Such intelligent devices 131 can further supply identifying information, and payment information to the merchant.

Accordingly, the customer is empowered to interact with the advertising system 100, and voluntarily obtain coupons that are considered desirable by such customer (e.g., not a spam). Since obtaining such coupon is intentional and favored by the customer (e.g., initiated by the customer), data related to “non-usage” (and after obtaining the coupon) becomes a valuable marketing criteria. For example, success (or failure) of advertising can be measured by comparing a “coupon-request”, rate to the actual “non usage” rate for such requested coupon.

The presentation component 110 can include various devices and software that facilitate the input and output (I/O) of information (e.g., speakers, microphones, displays, keyboards, input devices, and wireless interfaces for wireless devices used by the customers). Moreover, the presentation component 110 can further incorporate: a display unit 112 (e.g., LCD-liquid crystal display and/or plasma displays) for presenting one or more advertisements; an audio I/O system such as speakers and microphones for receiving customer speech or other speech or audio signals, and speakers for outputting audio signals associated with the advertisements or other information desired to be presented, or a combination thereof.

For example, the retail establishment can have multiple displays positioned at predetermined locations of stores, wherein customers are likely be able to see and/or hear presented advertisement tied to the coupons. The predetermined locations can include spaces that optimize a visibility likelihood for advertisements, such as ends of aisles, product shelves, entrances and exits, checkout counters, and the like. The presentation component 110 can further employ multiple presentation systems that are mounted throughout the establishment, and include wired and/or wireless systems to facilitate relocation. It is to be appreciated that the subject innovation is not so limited and the presentation system can also encompass advertising scenarios, such as displaying advertisements on display screen of a smart mobile devices carried by customers; displaying advertisement on a display mountable to a shopping cart employed by customers, and the like. Upon viewing a desired advertisement on the display screen, the user can request a coupon related to the advertised product or service.

The customers 127 can view advertisement over the presentation component 110. Such advertisement can be displayed to the customers 127 based on a context analysis for the customer (e.g., activities of customers such as presence of a user in a predetermined locations, items selected in electronic basket, other demographics, and the like). Accordingly, the customers 127 can be empowered to interact with the advertising system 100, and obtain a coupon related the displayed advertisement. Upon the user requesting the coupon (e.g., paper, electronic coupon), the system 100 can supply the coupon thereto (e.g., print paper coupon, transmit electronic data to a portable computing device 131.

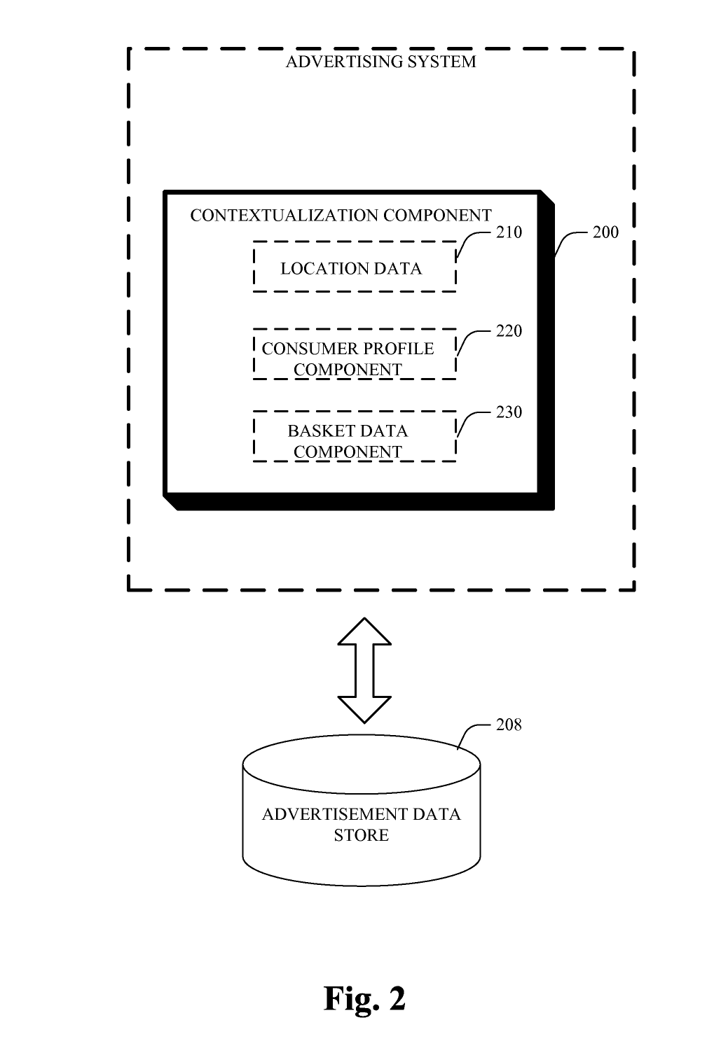

FIG. 2 illustrates a contextualization component 200 that can analyze contextual information related to the user and/or purchase transactions, to facilitate selection of advertisements for display to the customer or group of customers. The contextualization component 200 can analyze location data 210, and employ a consumer profile component 220, and basket data component 230, to facilitate selection of advertisements from a advertisement data store 208.

For example, location data can be obtained automatically via geographic location technologies, such as global positioning system, tracking information for shopping carts and mobile units carried by the customer, for example. Likewise, profile input 220 can be collected from prior user interaction with the web, e.g.,—prior user's search, the topic(s) of the search, the websites visited, pages visited on each website, and if a purchase was made, what was purchased, how the transaction was conducted, modes and delivery times, and the like.

Similarly, the basket data component 230 can employ current shopping behavior and/or interaction information that is accumulated based on user activity while in the retail establishment. Additionally, combination of web-based user activity and shopping activity while in the establishment can be analyzed and processed to select the desired advertisements and to present the ads to the user via the display component and/or other types of multimedia presentation systems when the user is detected in close proximity thereto. The model can also include information related to the user's preferences to brand, brand loyalty, pricing, and regularities in product purchases, for example.

Accordingly, based in part on analysis of the contextualization component 200 the advertisement data store 208 can be accessed to retrieve advertisements for presentation to the customer. In addition, remote or third-party advertisers can dynamically update and download advertisements for presentation to customers. Moreover, each advertisement packet can be tied to a coupon associated therewith, wherein the customer is empowered to interact with the advertising system, and obtain coupons that are considered desirable by the customer (e.g., non-spam).

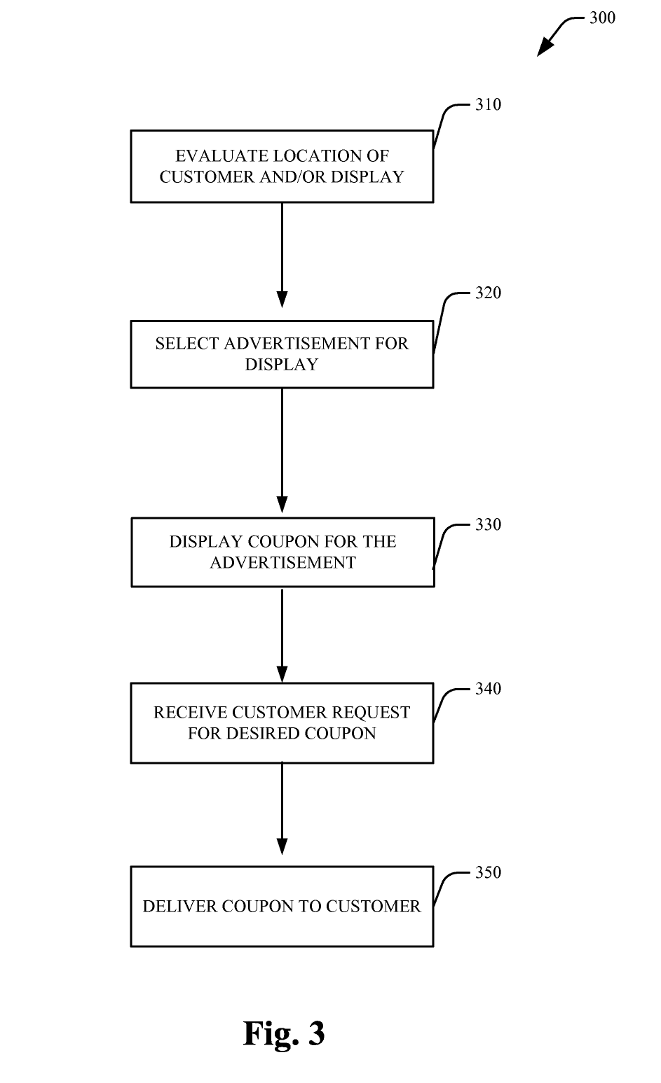

FIG. 3 illustrates a related methodology 300 of obtaining coupons that are tied to advertisement in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially and at 310, a location data for customers and/or location of a presentation display is evaluated. Such evaluation can include assessing type of premises that the display is located, to determine type of advertisements that is likely to draw attention.

For example, showing an advertisement for “bread” in a display located in an airport terminal is less likely to draw attention, then showing the same advertisement in a grocery store. Next, and at 320, relevant advertisement for display can be selected based on location of the display. Subsequently and at 330, the advertisement and a coupon for purchase thereof are displayed to the customer. At 340, a customer request for obtaining the coupon is received, and at 350, the coupon is delivered to the customer. Accordingly, the customer is empowered to interact with the advertising system, and the coupons obtained are considered desirable by the customer (e.g., non-spam). Moreover, since such coupon dispensing is voluntary (e.g., initiated by the customer), data related to “non-usage” of the obtained coupon becomes a valuable marketing criteria.

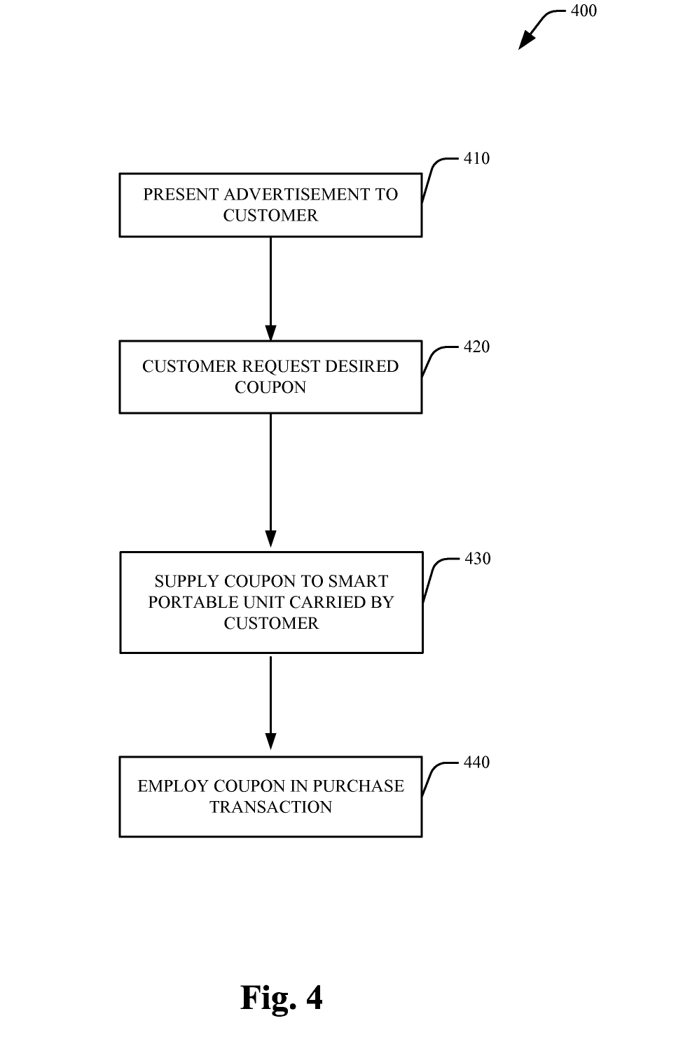

FIG. 4 illustrates a related methodology 400 of obtaining an electronic coupon by interacting with a display system, in accordance with an aspect of the subject innovation. Such electronic coupon can implement unique single instance of a string that carries monetary value and allows a customer who request such coupon from the advertising system to be eligible to purchase an offer. Initially at 410, an advertisement is presented to a customer based on a context analysis for such customer (e.g., presence of the customer in predetermined locations, electronic basket, demographics, and the like). The customer can posses a smart portable device—e.g., intelligent devices with computing and processing capabilities, such as portable computers, personal digital assistants, mobile phones, digital music players and the like, which can further supply identifications and communicate with the advertising system (e.g., display unit) to obtain an electronic coupon. The smart portable device can connect to the advertising system over a cell network, public wireless network, merchant's wired or wireless network or over a Bluetooth or NFC connection and the like, for example. Subsequently, and at 420 the customer can request the coupon related the displayed advertisement. Upon the user requesting the electronic coupon and at 430, the system can supply the coupon to the smart portable unit that is carried by the customer. At 440, the coupon can be employed in a purchase transaction, wherein the coupon is for a predetermined merchant and cannot be altered since the coupon is digitally signed by the issuing entity.

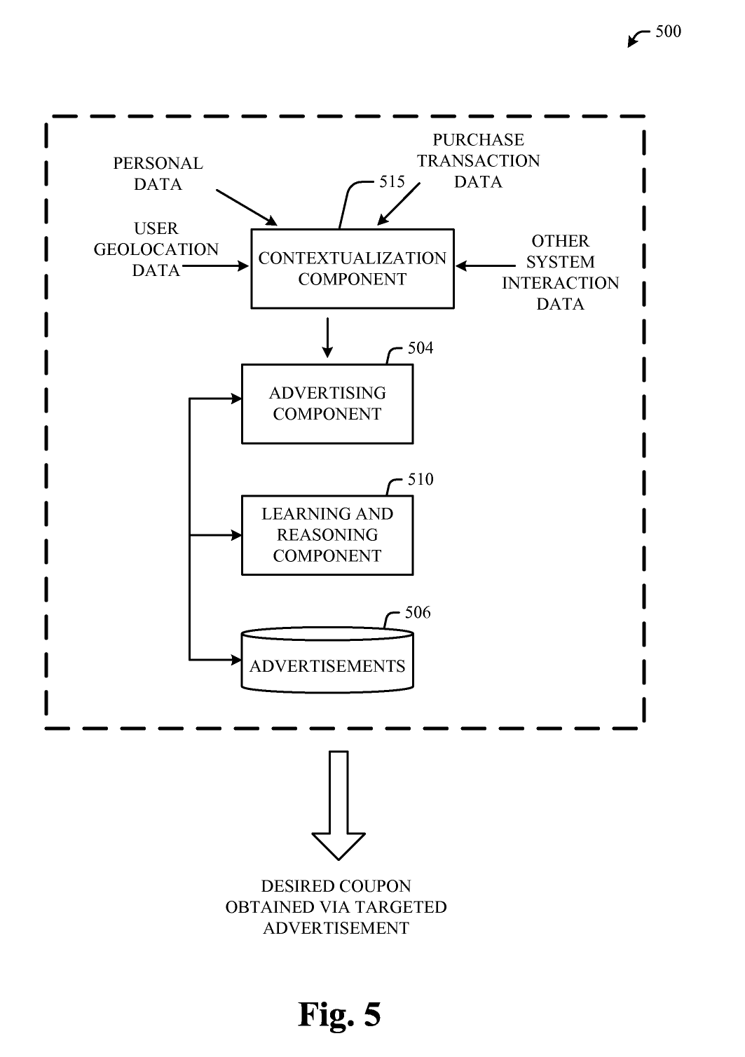

FIG. 5 illustrates an advertising system that employs a machine learning and reasoning in accordance with an aspect of the subject innovation. The machine learning and reasoning component 510 can dynamically tune the associations between advertisements—and—relevance of coupons for customers. As explained earlier, inputs to the contextualization component 515 can include user geolocation data (which can be obtained automatically via geographic location technologies, e.g., global positioning system), personal data (which includes personal financial data, person medical data, personal family data, and the like), purchase transaction data (related to purchases made via retail brick-and-mortar establishments, as well as online purchases), and system interaction data (e.g., television content viewing, cell phones, computers, and the like) associated with other systems that can be operated offline.

The advertising component 504 can select an advertisements stored in the advertisements data store 506. The selected advertisement can have a format that includes audio content, a still image content, video content, textual content, or any combination thereof. Selection of the format of the content can be based on the analysis of the contextualization component 515, and the learning and reasoning component 510. A coupon dispenser component (not shown) can then dispense the coupons based on customer initiation (e.g., pressing a button), and hence the dispensed coupons are considered desirable by such customer (e.g., not a spam).

Hence, the advertising system 500 can display ads with a high probability of successful redemption of associated coupons related thereto. For example, a process for determining which advertisement to select based on the user profile can be facilitated via an automatic classifier system and process. Moreover, where the data store 506 of advertisements can be distributed over several locations, wherein the classifier is employed to determine which data store location will be selected for advertisements.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or other statistical analysis (e.g., one factoring into the analysis utilities and costs to maximize the expected value to one or more people) to prognose or infer an action that a user desires to be automatically performed.

As used herein, terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, for example, naive Bayes, Bayesian networks, decision trees, neural networks, fuzzy logic models, and probabilistic classification models providing different patterns of independence can be employed. Classification as used herein also is inclusive of statistical regression that is utilized to develop models of ranking or priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be employed to automatically learn and perform a number of functions according to predetermined criteria.

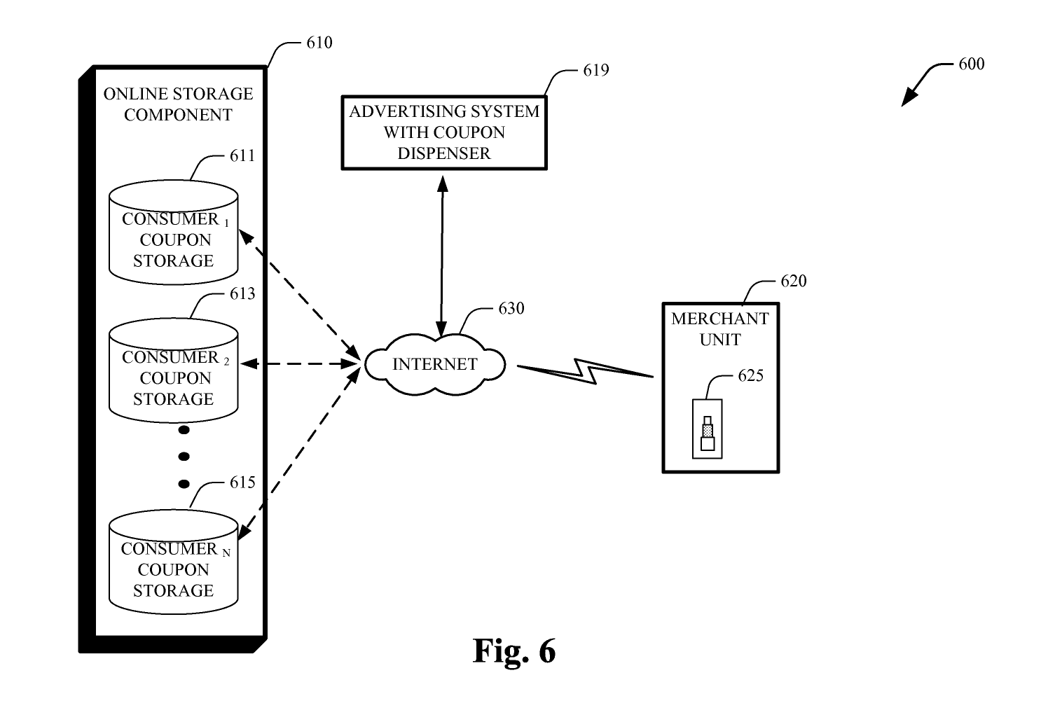

FIG. 6 illustrates a block diagram of a shopping network system 600 that employs an advertising system 619 with a coupon dispenser, which empowers customers to obtain coupon therefrom. Customers can then save their obtained coupons to an online storage component 610, which stores coupon data for a consumer (e.g., regardless of which issuer has issued the coupon.) The online storage component 610 can store coupons online in storage mediums 611, 613, 615 (1 thru N, where N is an integer) that can represent a single location for each consumer. Such online storage component 610 can operate without being tied to a particular service, and can readily provide redemption (e.g., an automatic redemption). The consumer and other retail entities (e.g., coupon issuers, merchant units 620, and the like) can populate the online storage component periodically, or in response to predetermined events (e.g., physical location of consumer, associated demographics, and the like.) As illustrated, the merchant terminal 625 can be communicatively coupled to the merchant unit 620, and the online storage component 610, via the internet 630.

Moreover, the online storage component 610 can function as an online service, wherein users (e.g., consumers) can register therewith to store their coupons therein. Accordingly, the online storage component 610 can aggregate coupons collected from the advertising system (e.g., paper coupons, electronic coupons) therein—via submission thru the internet 630. Such service can organize collected coupons, facilitate a search thereof, and mange redemption and access to the collected coupons. During a purchase transaction, users redeem coupons that are related to the purchase via an identification process, wherein the terminal 625 receives such coupons and can apply them to the user's shopping basket at checkout. Items in basket of the consumer can be matched with coupons stored for each respective client storage 611, 613, 615 and rules relating thereto (e.g., discourage using the coupons for the same identical transaction.)

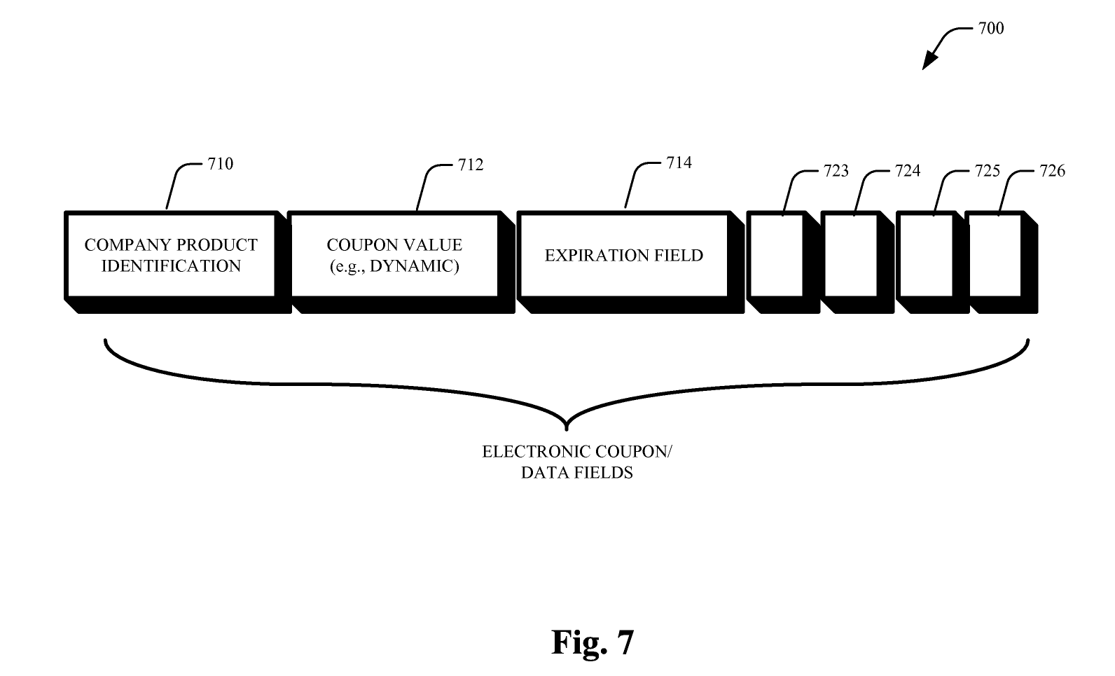

FIG. 7 illustrates an exemplary packet format for coupon files that customers can obtain from the advertising system of the subject innovation. The electronic coupon 700 can be submitted by the advertising system to an intelligent device carried by a customer, or can be printed in the paper form. Associated data can include shopping list/purchase files and price look up files. The coupon file packet 710 can represent company product identification, and a coupon value field 712 can include information relating to the value of the coupon 700. The field 712 can include a formula for use in the case where the coupon value is dynamic in nature. Moreover, an expiration field 714 can include data relating to when the coupon 700 expires. In addition, a bitmap icon field 723 includes data that can be used to generate an icon representing the product the coupon associated therewith. A manufacturer's website field 724 includes link information to the web site of the manufacturer that issued the coupon 700. A product data field 725 includes information relating the product the coupon is associated therewith. A date used field 726 includes data relating to when the coupon was actually used by the customer.

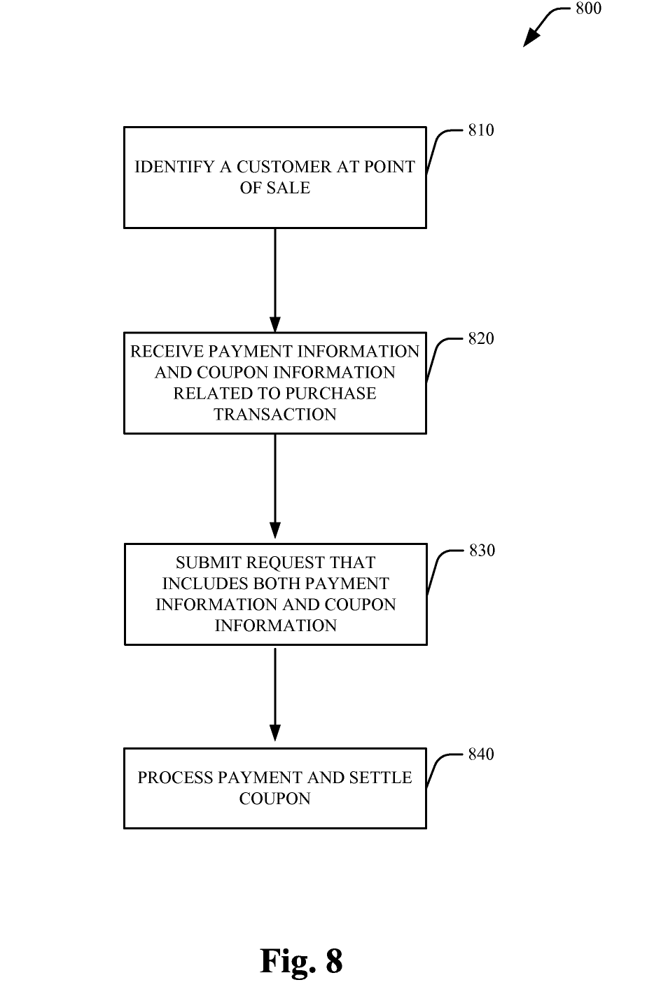

FIG. 8 illustrates a further methodology 800 of settling coupons that are obtained via customer initiation, according to a further aspect of the subject innovation. Initially and at 810 a point of sale (POS) terminal can identity a customer via a portable intelligent device (e.g., a mobile computer, a personal digital assistant, a cell phone, and the like), which is carried by the customer or by other identification methods such as a magnetic stripe card, driver's license, customer's biometric data, and the like. Next, and at 820 such POS terminal receives payment information and coupon information that are obtained through an advertising system, as described in detail supra. At 830, the POS can submit a request that includes both the payment information and coupon information to a processing entity that combines service for processing of the payment and settlement of the coupon earlier obtained by the customer. Subsequently and at 840, the processing entity processes the payment (e.g., via submittal to a bank) and settles the coupon (e.g., submittal to the coupon issuing entity for redemption by merchant). It is to be appreciated that other implementations such as instances wherein customers pay with cash or check, or without employing an electronic processing medium are well within the realm of the subject innovation.

As used in herein, the terms “component,” “system” and the like are intended to refer to a computer-related entity, either hardware, a combination of hardware and software, software or software in execution. For example, a component can be, but is not limited to being, a process running on a processor, a processor, an object, an instance, an executable, a thread of execution, a program and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

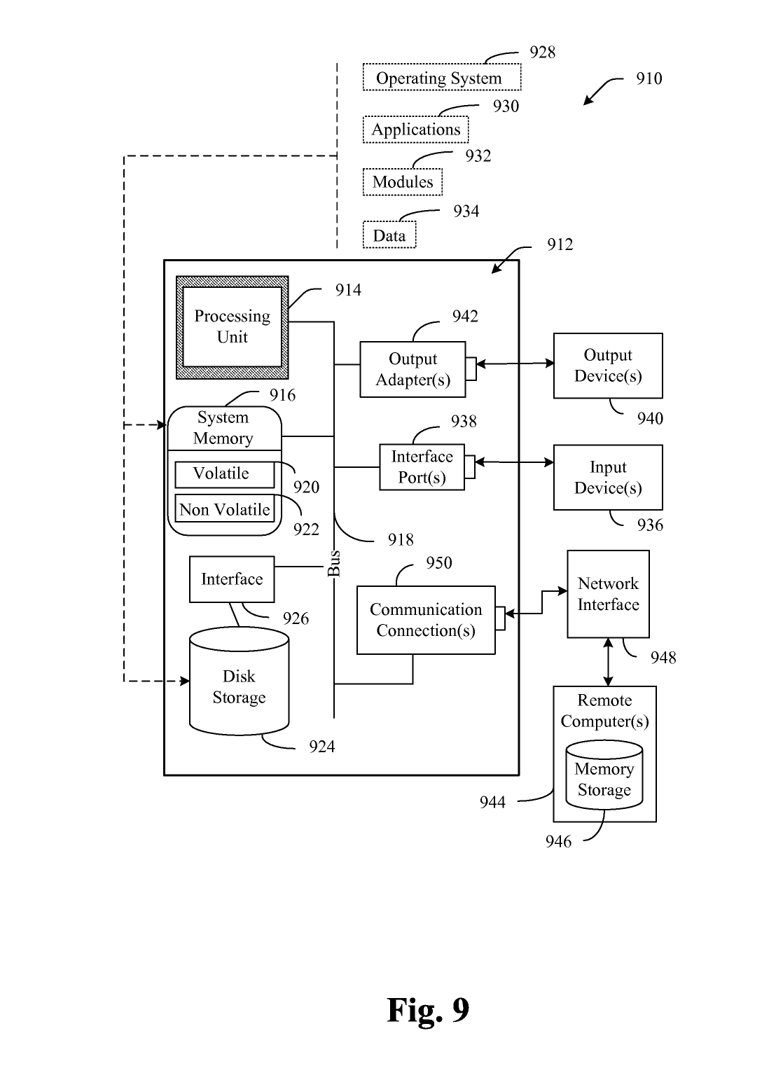

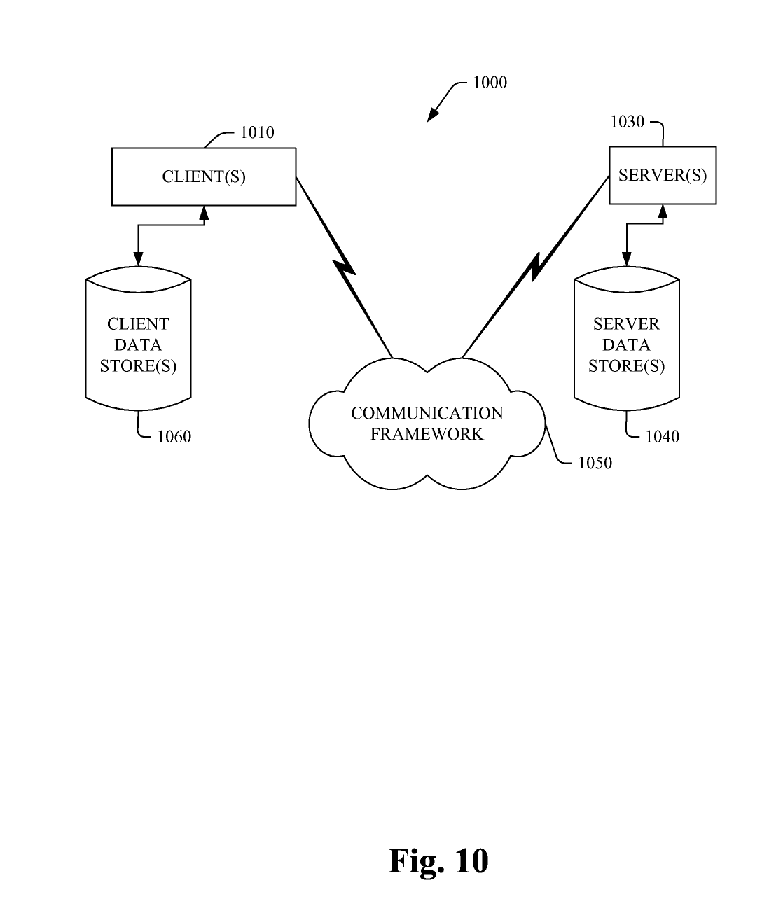

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates a disk storage 924, wherein such disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed as part of the advertising system in accordance with an aspect of the subject innovation. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising:
a contextualization component that analyzes context of activities related to a customer, for a display of an advertisement thereto; and
a coupon dispenser component that dispenses a coupon(s) related to the advertisement based on a request by the customer.

2. The computer implemented system of claim 1 further comprising a presentation component that presents the advertisement to the customers.

3. The computer implemented system of claim 2 further comprising a location component that evaluates location of the presentation component or the customer or a combination thereof.

4. The computer implemented system of claim 2, the context of the purchase based on a profile of the customer or basket thereof.

5. The computer implemented system of claim 1 further comprising a machine learning component that facilitates ad selection for presentation to the customer.

6. The computer implemented system of claim 1 further comprising an advertisement data store for storage of advertisements.

7. The computer implemented system of claim 6 further comprising an advertisement component that selects advertisements from the data store.

8. The computer implemented system of claim 1 further comprising an online storage component that stores coupons dispensed from the coupon dispenser component.

9. The computer implemented system of claim 1, a value of the coupon dynamically updateable.

10. A computer implemented method comprising:
displaying an advertisement to a customer; and
receiving a request from the customer for issuing a coupon related to the advertisement.

11. The computer implemented method of claim 10 further comprising displaying the advertisement based on analyzing a context of purchase related to activities of the customer.

12. The computer implemented method of claim 11, the analyzing act based on a location of the customer.

13. The computer implemented method of claim 11, the analyzing act based on profile of the customer.

14. The computer implemented method of claim 11 further comprising transferring an electronic coupon to a smart mobile device of the customer or coupon account.

15. The computer implemented method of claim 11 further comprising dynamically updating the advertisement.

16. The computer implemented method of claim 11 further comprising employing non-usage of the coupon as a marketing criteria.

17. The computer implemented method of claim 11 further comprising delivering the coupon to the customer in form of a paper coupon.

18. The computer implemented method of claim 11 further comprising submitting payment data and coupon data as a single request to a processing entity.

19. The computer implemented method of claim 11 further comprising changing a value of the coupon.

20. A computer implemented system comprising:
means for analyzing context of activities related to a customer, for a display of an advertisement thereto; and
means for dispensing a coupon related to the advertisement based on customer initiation.
